(19) United States
(12) Patent Application Publication
(10) Pub. No.: US 2018/0026279 A1
(43) Pub. Date: Jan. 25, 2018

(54) TOROIDAL SCAVENGED RESERVOIR FOR FUEL CELL PURGE LINE SYSTEM

(71) Applicant: Ford Global Technologies, LLC, Dearborn, MI (US)

(72) Inventor: Seha SON, Ann Arbor, MI (US)

(21) Appl. No.: 15/217,255

(22) Filed: Jul. 22, 2016

(51) Int. Cl. H01M 8/04119; H01M 8/04223

(52) U.S. Cl. CPC H01M 8/04179; H01M 8/04223; H01M 8/04253; H01M 8/04231

(57) ABSTRACT

A fuel cell system includes a fuel cell stack, a separator and a scavenging reservoir. The separator is downstream of and in fluid communication with the fuel cell stack. The scavenging reservoir is downstream of and in fluid communication with the separator. The scavenging reservoir includes an inlet, an outlet, and a partially toroidal middle interconnecting the inlet and outlet. The partially toroidal middle has a radius of curvature, a torus diameter, and an arc length selected such that a minimum volume of liquid necessary to completely block passage of fluid therethrough is the same over a range of tilt angles defined by the minimum volume of liquid, the radius of curvature, and torus diameter. The arc length is based on the radius of curvature and the torus diameter.

### TECHNICAL FIELD

The present disclosure relates to a fuel cell purge line system.

### BACKGROUND

During fuel cell operation, byproducts such as product water and nitrogen, as well as unconsumed hydrogen, may form at the anode side of a fuel cell stack. In certain known systems, accumulation of product water and nitrogen accumulation is controlled in an attempt to avoid a reduction in fuel cell performance, and/or fuel cell system shut down. One known approach is to release the water and nitrogen via a passageway downstream of the fuel cell stack. Using such approach, the passageway is coupled with a valve for the controllable release of water and nitrogen from the fuel cell stack. This approach causes the potential for problems to occur during cold weather operation of the fuel cell when water may freeze in the passageway, or valve, or other regions of the fuel cell with small cross sectional areas. The resulting ice formation may cause blockage of at least a portion of the passageway and prevent fluid flow (e.g., water and nitrogen removal), which may inhibit fuel cell system function.

### SUMMARY

A combined water and anode knock-out purge line for a fuel cell includes an inlet portion having a first end, an outlet portion symmetrical to the inlet portion about a central axis and having a second end, and a partially toroidal middle portion. The partially toroidal middle portion interconnects the inlet portion and the outlet portion. The partially toroidal middle portion has a radius of curvature, a torus diameter, and an arc length selected such that a minimum volume of liquid necessary to completely block passage of fluid therethrough is the same over a range of tilt angles. The range of tilt angles are defined by the minimum volume of liquid, the radius of curvature, and torus diameter. The arc length is based on the radius of curvature and the torus diameter.

A fuel cell system includes a fuel cell stack, a separator and a scavenging reservoir. The separator is downstream of and in fluid communication with the fuel cell stack. The scavenging reservoir is downstream of and in fluid communication with the separator. The scavenging reservoir includes an inlet, an outlet, and a partially toroidal middle interconnecting the inlet and outlet. The partially toroidal middle has a radius of curvature, a torus diameter, and an arc length selected such that a minimum volume of liquid necessary to completely block passage of fluid therethrough is the same over a range of tilt angles defined by the minimum volume of liquid, the radius of curvature, and torus diameter. The arc length is based on the radius of curvature and the torus diameter.

A fuel cell scavenging reservoir includes a partially toroidal middle interconnecting an inlet and outlet. The partially toroidal middle has a radius of curvature, a torus diameter, and an arc length selected such that a minimum volume necessary to completely block fluid passage therethrough is equal over a tilt angle range defined by the minimum volume, the radius of curvature, and torus diameter. The arc length is based on the radius of curvature and the torus diameter.

### BRIEF DESCRIPTION OF THE DRAWINGS

FIG. 1A depicts an isolated, perspective view of a scavenging reservoir in an embodiment;

FIG. 1B depicts a schematic drawing of a fuel cell system and a cross-sectional view of the scavenging reservoir of FIG. 1A taken along line 1B-1B;

FIG. 1C depicts a longitudinal cross-sectional view of an alternative scavenging reservoir according to another embodiment;

FIG. 1D depicts a cross-sectional view of the scavenging reservoir of FIG. 1A taken along line 1D-1D;

FIG. 2 depicts a variation of the fuel cell system referenced in FIG. 1B including a supplemental purge passageway;

FIG. 3A depicts a variation cross-sectional view of a scavenging reservoir;

FIG. 3B depicts a variation cross-sectional view of a scavenging reservoir;

FIG. 3C depicts a variation cross-sectional view of a scavenging reservoir;

FIG. 3D depicts a variation cross-sectional view of a scavenging reservoir;

FIG. 3E depicts a variation cross-sectional view of a scavenging reservoir;

FIG. 3F depicts a variation cross-sectional view of a scavenging reservoir; and

FIG. 3G depicts a variation cross-sectional view of a scavenging reservoir.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

During fuel cell operation, product water, residual fuel such as hydrogen, and byproducts such as nitrogen may accumulate at the anode side of the fuel cell stack. Attempts have been made to remove the liquid product water and byproducts and to reuse the residual hydrogen and water vapor. One approach is to collect those constituents in a separator downstream of the fuel cell stack, separate liquid water and direct it towards a combined purging and draining passageway, and return the remaining constituents to the fuel cell stack via a return passageway. The combined purging and draining passageway is closed to the atmosphere by a single valve. Periodically, this valve is opened to drain liquid product water and purge the anode of byproducts such as nitrogen. However, combining the purging and draining functions into a single passageway closed by a single valve presents significant risk of ice formation and blockage of purge and drain flow when residual product water freezes during exposure to cold ambient temperatures. The potential for ice formation is an acute concern in cold ambient temperatures below 0° C. If the purging and draining functions are inhibited by ice blockage, then fuel cell system performance degrades, potentially to the point of system shut down.

The embodiments of the present invention, as will be described herein, provide a solution to one or more of the above-identified problems. One or more embodiments delivers a reduction in system complexity by incorporating new structures into an existing purge passageway, avoiding the use of multiple valves and passageways for startup robustness, therefore keeping hardware and control software to a minimum. Reduction in complexity may result in a reduction in manufacturing cost, a reduction in system weight, and/or a reduction in failure mode occurrence.

In one or more embodiments, a fuel cell system with a scavenging reservoir positioned downstream of a fuel cell stack is disclosed. The scavenging reservoir may provide one or more of the following benefits: (1) a reduction and/or elimination of purging passageway blockage due to ice formation and (2) a reduction in the number of valves for purging both nitrogen and water. In certain instances, nitrogen, water, and hydrogen may flow through the same passageway employing the scavenging reservoir with a single downstream valve. This approach may be alternatively referred to as an integrated purge and drain function. This approach supports the endeavor of obtaining a commercially-viable fuel cell system design that is capable of consistently starting in freezing ambient conditions while reducing costs and improving efficiency. In addition, and as detailed herein, the product water is less of a threat for causing ice blockage during cold weather conditions.

As disclosed herein, the term “scavenging” may refer to the act of flowing the anode purge and drain gas stream over and through the accumulated liquid water to physically remove the water.

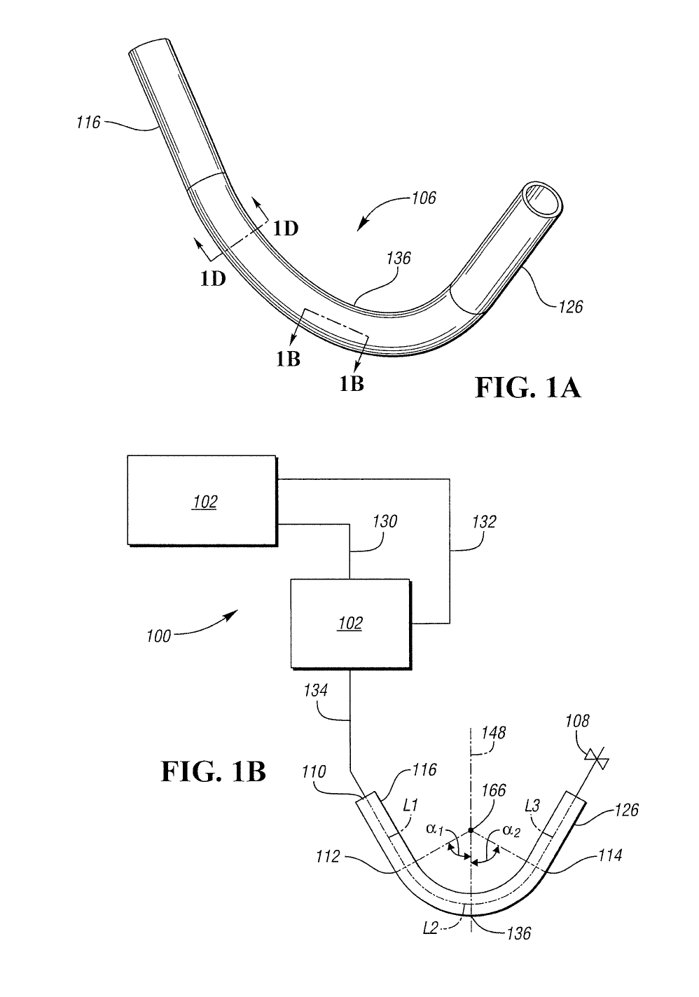

In one or more embodiments, and as depicted in FIGS. 1A and 1B, a fuel cell system generally shown at 100 may include a fuel cell stack 102, a separator 104 downstream of and in fluid communication with the fuel cell stack 102 via a passageway 130, and a scavenging reservoir 106 downstream of and in fluid communication with the separator 104, wherein the scavenging reservoir 106 includes an inlet portion 116, an outlet portion 126, and a middle portion 136 positioned between and interconnecting the inlet and outlet portions 116, 126. As will be described in more detail below, the lower surface of inlet portion 116 is positioned with an inlet angle α1 relative to the lower surface of the middle portion 136. The lower outlet portion 126 is positioned with an outlet angle α2 relative to the lower surface of the middle portion 136. Valve 108 is positioned downstream of the reservoir 106. As described herein, this structure of the scavenging reservoir 106 may maintain a passageway during cold weather conditions and keep the passageway valve free of ice blockage.

During fuel cell system operation, product water, nitrogen, and residual hydrogen may flow from the fuel cell stack 102 into the separator 104 via the passage 130. In the separator 104, the product water is separated from the residual hydrogen and nitrogen. The product water exits the separator 104 through passage 134. In certain instances, and as depicted in FIG. 1B, the separated hydrogen may be returned back to the fuel cell stack 102 via a hydrogen return passageway 132.

In one non-limiting embodiment, the scavenging reservoir 106 can be formed as a detachable unit with dimensions that comply to any fuel cell system where water freeze may be an issue. The scavenging reservoir can also be incorporated into the bottom of the water knockout itself. The scavenging reservoir may be an integral single unit, optionally formed via injection molding. A benefit of this configuration is that preferred liquid leakage may be reduced at the angled sections, which may otherwise require welding and/or soldering to connect. However, the inlet, outlet and middle portions can be connectable pieces with sizes and materials separately customizable for each fuel cell system. For instance, the middle portion may have a cross-sectional diameter greater than, equal to or smaller than that of either of the inlet portion and the outlet portion. For instance also, one may choose to have a middle portion formed of a material different from that of either of the inlet portion and the outlet portion.

By reducing the total number of valves to one, which is the combined purge and drain valve 108, and by employing the scavenging reservoir 106 upstream of the valve 108, the present disclosure in one or more embodiments provides a synergistic effect of preventing ice blockage and scavenging product water.

The scavenging reservoir 106 may be in fluid communication with an anode of the fuel cell stack 102 or a cathode of the fuel cell stack 102. When used in fluid communication with the cathode, the scavenging reservoir 106 may help prevent items such as an electronic throttle body from freezing.

The scavenging reservoir 106 and more particularly the middle portion 136 thereof is positioned below the separator 104 along the direction of gravity so that water can drain via gravity into the scavenging reservoir 106. Along this passageway, a valve 108 positioned downstream of the scavenging reservoir 106 should be at a position above the scavenging reservoir 106 along the direction of gravity so that any water which would otherwise reside on or around the valve 108 would then accumulate in the middle portion 136. The water should accumulate in the middle portion 136 in such a manner as to permit gas passage through the middle portion 136, even if any accumulated water forms ice. The valve 108 can be a closed solenoid valve.

Referring specifically to FIG. 1B, the inlet portion 116 may be configured as a substantially cylindrical or cylindrical structure including the first end 110 and the second end 112, with an inlet length Ln1 measured down the centerline axis L1. In certain embodiments, the inlet length Ln1 of the inlet portion 116 has a value of 0.5 to 10 inches, 1.0 to 5 inches, or 2.0 to 3.0 inches.

In certain embodiments, the combination of centerline axes L1, L2 and L3 constitutes a longitudinal axis of the scavenging reservoir. Further, the cross-sectional views of the scavenging reservoirs 106 and 106′ depicted in FIGS. 1B and 1C may be considered latitudinal cross-sectional views.

This paragraph relates to the installation of the combined water and anode knock-out purge line in a fuel cell within a vehicle. The centerline axis L2 of the middle portion 136 can be positioned relative to the direction of gravity and symmetrical about the central axis 148 between the second end 112 and the third end 114 at an angle of about 65.5 to about 114.5 degrees, about 70 to about 110 degrees, or about 85 to about 95 degrees. The middle portion 136 as positioned in relation to and between the inlet portion 116 and the outlet portion 126 acts as a hemispherical bowl for water to reside on a bottom surface of the middle portion 136, leaving an upper space for gas flow.

FIG. 1C depicts a scavenging reservoir 106′ showing water or ice 140 accumulated on the lower surface 152 of the middle portion 136′, with a clear flow path above the water or ice accumulation. During nitrogen purging and water draining events, the flow of warm anode byproducts melts ice and entrains liquid water accumulated in the middle portion 136′. In this configuration, the product water and nitrogen gas can be purged substantially evenly in the presence of ice in the passageway. This design, therefore, provides a synergistic effect in that not only the nitrogen gas and the product water can be purged via a single passageway with a single downstream valve to reduce system complexity and maintenance cost, but also provides built-in warming and melting effectuated via the fluid mixture passing through the scavenging reservoir 106′.

Several factors can be considered in shaping the scavenging reservoir. These factors may include designing the inlet and outlet angles, the inlet, outlet, and reservoir cross sectional areas, and the length, width, and depth of each section of the scavenging reservoir in response to flow stream characteristics, which in themselves are a function of load as dictated by usage cycle. In general, the scavenging reservoir should be designed with dimensions effectuating sufficient storage of product water during a soak to avoid system blockage upon a subsequent start up attempt. In certain embodiments, the angles of the inlet to and outlet from the reservoir should be upward to facilitate gravity drainage of water into the reservoir for storage and freezing. Moreover, the position of the water and anode knock-out purge line installed in a vehicle should also take into consideration road pitch resulting in a tilt angle of the scavenging reservoir 106′. For example, the reservoir should account for a road pitch, and likewise a tilt angle of the reservoir, ±17° to facilitate gravity drainage of water into the reservoir for storage and freezing. Those skilled in the art know that road pitch may deviate greatly from being nearly planar to mountainous roads having steep inclines and declines which may exceed ±3°, ±5°, ±8°, ±11°, ±15°, ±18°, ±21°, and ±25°, which the scavenging reservoir should have a corresponding tilt angle range great enough to overcome.

The inlet portion, the outlet portion and/or the middle portion can each be structured with any suitable geometrical features, including ribbing and vanes, which may straighten or direct fluid flow, or even add turbulence to the fluid flow. Such manipulation of the fluid flow may enhance scavenging during operation, or could be used to direct water flow during non-operation prior to freezing.

The water should accumulate entirely or significantly in the middle portion 136 in such a manner as to permit gas passage through the middle portion 136 even if any accumulated water forms ice. The geometry of the scavenging reservoir 106′ may also define a minimum volume of liquid 140 that completely blocks gas passage through the middle portion 136. In the embodiment shown in FIG. 1C, the middle portion 136 may be substantially toroidal. The substantially toroidal middle portion 136 allows the minimum volume of liquid 140 to be the same throughout a range of tilt angles being consistent with the road pitch angles described above. For example, the scavenging reservoir 106′ may define a tilt angle θ that equals the road pitch based on the position of the vehicle on the road, and the toroidal shape of the middle portion 136 maintains a constant and consistent minimum volume of liquid 140 throughout the range of tilt angles based on the corresponding road pitches, as shown in FIG. 1C.

As described above, the middle portion 136 may define a toroid. The toroidal middle portion 136 includes a radius of curvature 142, a torus diameter 144 and an arc length 146. The radius of curvature 142, the torus diameter 144 and the arc length 146 are defined such that the middle portion 136 maintains the same minimum volume of liquid 140 throughout the range of tilt angles. More specifically, the arc length 146 is defined by the radius of curvature 142 and the torus diameter 144 to allow the scavenging reservoir 106′ to have a tilt angle range to account for the range of road pitches described above. By maintaining the same minimum volume of liquid 140, the middle portion 136 allows the scavenging reservoir 106′ to maintain the blockage characteristics of the minimum volume of liquid 140 through a range of tilt angles θ. As shown in FIG. 1C by way of example, the range of tilt angles θ is shown to be ±19.5 degrees from the central axis 148. As stated above, the range of tilt angles θ may be based on the road pitch and vary with the road pitch. Therefore, using a toroidal middle portion 136 allows for a greater passage area for purging.

The radius of curvature 142 of the middle portion 136 may be aligned with a central axis 148 of the scavenging reservoir 106′. As will be described in more detail below, the inlet portion 116 may define a latitudinal cross-section between a first end 110 and a second end 112. In a similar manner, the outlet portion 126 may define a latitudinal cross-section between a third end 114 and a fourth end 118. The middle portion 136 is defined between the second and third ends 112, 114. The inlet angle α1 may be defined between the latitudinal cross-section of the second end 112 of the inlet portion 116 and the radius of curvature 142 of the middle portion 136. Likewise, the outlet angle α2 may be defined between the latitudinal cross-section of the third end 114 and the radius of curvature 142 of the middle portion 136. The inlet angle α1 and the outlet angle α2 allow the scavenging reservoir 106′ to have a gradual blockage increase, facilitating purging when the scavenging reservoir is tilted.

The inlet angle α1 and/or the outlet angle α2 may be configured to facilitate directing water into the middle portion 136 during soak events. This helps to permit ice to form in the middle portion 136 and away from passageways that may be relatively more sensitive to bridging and blockage. The inlet angle α1 may be less than about 90 degrees and greater than about 45 degrees. In certain instances, the inlet angle α1 is between about 70 to about 50 degrees, about 60 to about 50 degrees, about 58.4 to about 45 degrees, or about 58.4 to about 45 degrees. The outlet angle α2 may be less than about 90 degrees and greater than about 45 degrees. In certain instances, the outlet angle α2 is between about 70 to about 50 degrees, about 60 to about 50 degrees, about 58.4 to about 45 degrees, or about 58.4 to about 45 degrees. The inlet angle α1 and the outlet angle α2 may be equal. In certain instances, the inlet angle α1 and the outlet angle α2 may be symmetrical about the central axis 148 and extending from the central axis 148 to the second end 112 and the third end 114, respectively. Therefore, the inlet angle α1 and the outlet angle α2 may be symmetrical across the arc length 146 of the middle portion 136. The inlet angle α1 and the outlet angle α2 may combine to be about 116.7 degrees.

Referring to FIG. 1D, the middle portion 136 may be configured as substantially cylindrical or a cylindrical structure including a centerline axis L2 and defined between the second end 112 and a third end 114. The cylindrical structure shown in 1D depicts a lower surface 152 and upper surface 150. The middle portion 136 may have a length Ln2 measured down the centerline axis L2 and ending between the second and third ends 112, 114. In certain designs, the length Ln2 of the middle portion 136 has a value of 0.5 to 10 inches, 1.0 to 5 inches, or 2.0 to 3.0 inches. In one or more embodiments, the middle portion length Ln2 is configured such that scavenging water is not dropped out of the purge and drain flow stream and back into the reservoir before reaching the outlet portion (in this case, the middle portion would be too long).

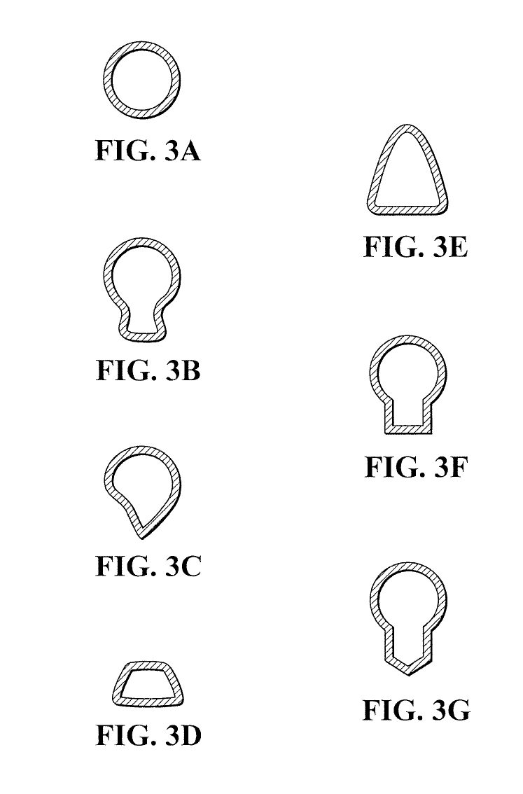

In alternative embodiments, referred to in FIGS. 3A-3G, the middle portion 136 may be configured in various shapes construed or varying longitudinal cross-sectional shapes suitable with dimensions effectuating sufficient storage of product water during a soak to avoid system blockage upon a subsequent start up attempt. FIGS. 3A-3G represent alternative embodiments which the angles of the inlet to and outlet from the reservoir are upward to facilitate gravity drainage of water into the reservoir for storage and freezing. FIGS. 3A-3G depict a variation of cross-sectional views of the scavenging reservoir of FIG. 1A taken along line 1D-1D, wherein FIG. 3A is circular or substantially circular, FIGS. 3B-3G have a drainage reservoir that allows gravity drainage of water into the reservoir for storage and freezing. FIGS. 3B-3G may be turned relative to a central point fixed axis, in 15°, 30°, 45°, 60°, 75°, 90°, 105°, 120°, 135°, 150°, 165°, and 180°.

The outlet portion 126 may be configured as a substantially cylindrical structure or cylindrical including a centerline axis L3 and defined between the third end 114 and a fourth end 118. The outlet portion 126 may have a length Ln3 measured down the centerline axis L3 and ending between the third and fourth ends 114, 118. In certain designs, the length Ln3 of the outlet portion 126 has a value of 0.5 to 10 inches, 1.0 to 5 inches, or 2.0 to 3.0 inches. Without wanting to be limited to any particular theory, the outlet portion 126 is configured such that scavenging water is not dropped back into the reservoir before reaching the purge and drain valve.

When the inlet portion is cylindrical or substantially cylindrical, the inlet portion 116 may have an average diameter of 5 to 20 mm, 7.5 to 17.5 mm, or 10 to 15 mm. In one or more embodiments, the inlet portion length Ln1 creates directionality to the fluid flow, imparting flow separation between the terminus of the inlet portion and the top of the middle portion and resulting in the fluid flow impacting the lowest inner surface of the middle portion. This action causes scavenging of the pool of water. In other embodiments, inlet portion 116 may be conical or frusto-conical tapered from a large base at 110 to the smaller base at 112.

The middle portion 136 may be cylindrical or substantially cylindrical, or any other suitable cross-section, such as rectangular or polygonal. When the inlet portion is cylindrical or substantially cylindrical, the middle portion 136 has an average diameter of about 12.5 to about 55 mm, about 40 mm, about 30 mm, about 25 mm, about 20 mm, about 15 to about 25 mm, or about 17.5 to about 22.5 mm. The middle portion 136 may be configured to have an average diameter greater than that of the inlet portion 116 and/or the outlet portion 126. The difference in average diameter values can be about 2 to about 11 mm, about 3 to about 10 mm, about 4 to about 9 mm, or about 5 to about 8 mm. These diameters may be configured such that a single droplet of water would not bridge or completely block a passageway due to capillary forces.

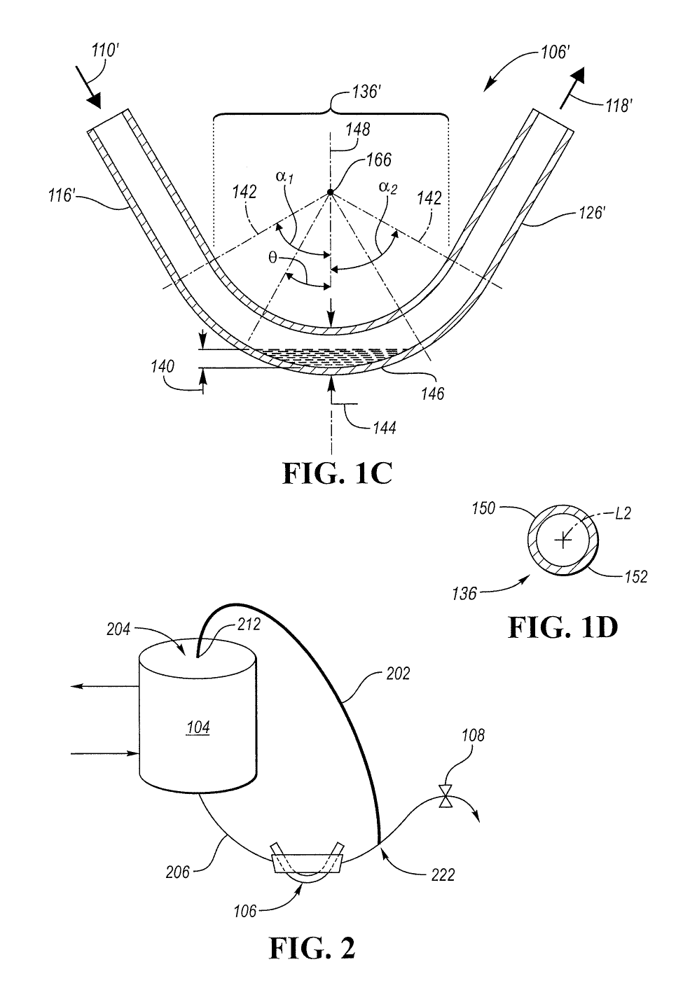

As depicted in FIG. 2, the fuel cell system may further include a supplemental purge passageway 202 to provide purging supplemental to that provided by the primary purge passageway where the scavenging reservoir 106 resides. The supplemental purge passageway may include a first end 212 and a second end 222, the first end 212 being connected to and/or received within a top portion 204 of the separator 104, the second end 222 being disposed upstream of the valve 108. In certain instances, the supplemental purge passageway 202 is connected to the primary purge passageway 206 at junction 224, wherein the second end 222 is disposed downstream of the scavenging reservoir 106 and upstream of the valve 108.

The incoming flow may include water in liquid and/or vapor states, hydrogen, and nitrogen, and the incoming flow passes through the primary and/or supplemental purge passageway in various concentrations. The extent of a flow through the supplemental purge passageway can be controlled such that the supplemental purge passageway may come into effect only when the primary purge passageway fails to provide the requisite amount of purging as desirable. This control can be done in a variety of ways, including the employment of a restriction device such as an orifice to restrict the flow through the supplemental purge passageway 202 or a valve such as a solenoid valve.

As depicted in FIG. 1B and FIG. 2, although the supplemental purge passageway 202 is separately disposed relative to the primary purge passageway, the supplemental purge passageway 202 may feed the same valve 108 used by the primary purge passageway, thereby keeping costs and parasitic losses low.

As detailed with reference to FIG. 1B, the middle portion 136 of the scavenging reservoir 106 remains the lowest region in the primary purge passageway relative to the passageway's origination from the separator 104. Similarly in FIG. 2, the middle portion 136 of the scavenging reservoir 106 also remains the lowest spot in the primary purge passageway relative to the second end 222 of the supplemental purge passageway 202. This relatively low region provides a region for water to accumulate away from areas that are sensitive to blockage from ice formation, such as the merge location (e.g., the second end 222) of the primary and supplemental passageways, or the orifice in the valve 108.

The supplemental purge passageway 202 is provided such that it originates at a location on top of the separator 104 that permits gas flow in the presence of ice blockages in the primary passageway. Passageway 202 merges with the primary passageway prior to the location upstream of the valve 108. The origination at the separator 104 may prevent accumulation of liquid water that could later freeze. The supplemental purge passageway 202 may contain an orifice (not shown) in the flow path to restrict fluid flow, ensuring that the majority of the purge and drain fluids flow through the primary passageway unless the primary is blocked or restricted by liquid water or ice.

Therefore, the supplemental purge passageway 202 serves as a bypass loop that will enable purge flow in the event that the primary purge passageway is blocked with ice until the primary purge passageway is thawed and able to flow both purge and drain fluids. In this arrangement the valve 108 must be located such that it is not the lowest component in the entire system to prevent it from being subjected to ice blockage.

In certain designs, the primary and secondary passageways can be formed out of a conductive material and be placed wholly or partially within another system pipe that carries warm gases or fluids, such as the cathode exhaust passageway coming out of the stack or a pipe carrying warm stack outlet coolant. In this manner, the passageways will be latently warmed by their surroundings, efficiently thawing any ice using waste heat. Suitable conductive materials include, but not limited to metal, copper, aluminum, composites, and the like.

In certain other designs, a heat source may be placed in close communication with the primary and secondary passageways to promote ice melt.

In certain other designs, the primary and the secondary passageways may be insulated wholly or partially to promote ice melt by prevention of heat loss.

In certain other designs, a water-vapor-permeable but water-liquid-impermeable membrane may be placed in the bypass purge passageway to keep liquid water out of the passageway to prevent ice blockage.

While exemplary to embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A combined water and anode knock-out purge line for a fuel cell comprising:
an inlet portion having a first end;
an outlet portion symmetrical to the inlet portion about a central axis and having a second end; and
a partially toroidal middle portion interconnecting the inlet portion and the outlet portion, having a radius of curvature, a torus diameter, and an arc length selected such that a minimum volume of liquid necessary to completely block passage of fluid therethrough is the same over a range of tilt angles defined by the minimum volume of liquid, the radius of curvature, and torus diameter, wherein the arc length is based on the radius of curvature and the torus diameter.

2. The purge line of claim 1, wherein the middle portion includes a reservoir.

3. The purge line of claim 1, wherein the first end has an inlet portion inclination angle defined by a latitudinal cross-section of the first end and the second end has an outlet portion inclination angle defined by a latitudinal cross-section of the second end.

4. The purge line of claim 3, wherein the inlet portion has an inlet inclination angle defining the inlet portion inclination between the radius of curvature of the middle portion and a second end of the inlet portion.

5. The purge line of claim 3, wherein the outlet portion has an outlet inclination angle defining the outlet inclination between the radius of curvature of the middle portion and a third end of the outlet portion.

6. The purge line of claim 3, wherein the inlet inclination angle and the outlet inclination angle are equal.

7. The purge line of claim 4, wherein the inlet inclination angle is less than about 90 degrees and greater than about 45 degrees.

8. The purge line of claim 5, wherein the outlet inclination angle is less than about 90 degrees and greater than about 45 degrees.

9. The purge line of claim 1, wherein the inlet portion is generally cylindrical, the outlet portion is generally cylindrical, and the middle portion is generally cylindrical.

10. A fuel cell system comprising:
a fuel cell stack;
a separator downstream of and in fluid communication with the fuel cell stack; and
a scavenging reservoir downstream of and in fluid communication with the separator, and including an inlet, an outlet, and a partially toroidal middle interconnecting the inlet and outlet, the partially toroidal middle having a radius of curvature, a torus diameter, and an arc length selected such that a minimum volume of liquid necessary to completely block passage of fluid therethrough is the same over a range of tilt angles defined by the minimum volume of liquid, the radius of curvature, and torus diameter, wherein the arc length is based on the radius of curvature and the torus diameter.

11. The fuel cell system of claim 10 further comprising a valve downstream of the outlet above the middle.

12. The fuel cell system of claim 10, wherein the scavenging reservoir is in fluid communication with an anode of the fuel cell stack.

13. The fuel cell system of claim 10, wherein the scavenging reservoir is in fluid communication with a cathode of the fuel cell stack.

14. The fuel cell system of claim 10, wherein the inlet and the outlet are formed symmetrical about a central axis defined by the toroidal middle.

15. The fuel cell system of claim 14, wherein the inlet is formed at a first angle between a first end of the inlet and the central axis being within a range between 45 and 65 degrees.

16. The fuel cell system of claim 15, wherein the outlet is formed at a second angle between a second end of the outlet and the central axis being within a range between 45 and 65 degrees.

17. The fuels cell system of claim 16, wherein the inlet and outlet are formed at a third angle between the first and second ends being about 116.7 degrees.

18. A fuel cell scavenging reservoir comprising:
a partially toroidal middle interconnecting an inlet and outlet, having a radius of curvature, a torus diameter, and an arc length selected such that a minimum volume necessary to completely block fluid passage therethrough is equal over a tilt angle range defined by the minimum volume, the radius of curvature, and torus diameter, wherein the arc length is based on the radius of curvature and the torus diameter.

19. The fuel cell scavenging reservoir of claim 18, wherein the radius of curvature is about 116.7 degrees

20. The fuel cell scavenging reservoir of claim 18, wherein the middle includes a reservoir defining a threshold volume level such that the middle defines a fluid passageway above the threshold volume level of the reservoir.
